(19) United States
(12) Patent Application Publication
(10) Pub. No.: US 2009/0201693 A1
(43) Pub. Date: Aug. 13, 2009

(54) SPLIT TROUGH REFLECTOR

(76) Inventors: Jeyachandrabose Chinniah, Belleville, MI (US); Edwin Mitchell Sayers, Saline, MI (US); Chris L. Eichelberger, Livonia, MI (US)

Correspondence Address: FRASER CLEMENS MARTIN & MILLER LLC, 28366 KENSINGTON LANE, PERRYSBURG, OH, 43551, US

(21) Appl. No.: 12/030,512

(22) Filed: Feb. 13, 2008

(51) Int. Cl. F21V 7/06; F21V 7/00

(52) U.S. Cl. 362/516; 362/347; 362/310

(57) ABSTRACT

A trough reflector for a lighting system is disclosed, wherein the trough reflector produces a lighting pattern having a stepped horizontal cut-off, maximizes collection efficiency, and minimizes undesirable beam patterns. The trough reflector includes a reflective surface having a substantially parabolic curvature for directing light, wherein the reflective surface is split into a first portion and a second portion. The second portion offset relative to the first portion of the trough reflector. The trough reflector further includes a plurality of reflective side walls disposed adjacent the reflective surface, wherein the reflective side walls cooperate with the reflective surface to direct light rays to form a desired lighting pattern.

### FIELD OF THE INVENTION

The present invention relates generally to reflectors for light sources used in automotive applications, and more particularly to trough reflectors for LED light sources.

### BACKGROUND OF THE INVENTION

LED headlamps typically form a low beam pattern using multiple lighting units. The lighting units are of a projector, a direct projector, or a reflector type. Projector units are preferred for forming a cut-off because they image an internal shield that can be tailored to a precise shape. (The “cut-off” is the high contrast transition between the light below the horizon which hits the road and glare light above the horizon). Direct projectors, which directly image an LED chip, can form a sharp (high contrast) cut-off, but require several chips to build a beam pattern with acceptable width. Reflector units can form a straight (horizontal) cut-off that is reasonably sharp. However, using a reflector unit to form the angled and stepped portion of the cut-off lowers a collection efficiency of the unit.

A particular type of reflector unit, a so-called trough reflector, is often desirable due to its simplicity, relative ease of manufacture, and high collection efficiency. A trough is an extruded parabolic section, with walls at the ends to “fold” the beam upon itself. It naturally produces a sharp horizontal cut-off and a smooth illumination pattern.

Trough units are often used in combination with the projector or the direct projector units to form the low beam lighting pattern. However, because the trough forms a horizontal cut-off and the other units form stepped cut-offs, there is an undesirable mismatch in the resultant beam pattern.

It would be desirable to have a trough reflector for a lighting system, wherein the trough reflector facilitates a lighting pattern having a stepped horizontal cut-off, maximizes collection efficiency, and minimizes undesirable beam patterns.

### SUMMARY OF THE INVENTION

Concordant and consistent with the present invention a trough reflector for a lighting system, wherein the trough reflector facilitates a lighting pattern having a stepped horizontal cut-off, maximizes collection efficiency, and minimizes undesirable beam patterns, has surprisingly been discovered.

In one embodiment, a trough reflector comprises a reflective surface having a substantially parabolic curvature for directing light, wherein the reflective surface includes a first portion and a second portion, the first portion reflecting light in a first lighting pattern and the second portion reflecting light in a second lighting pattern; and a reflective side wall disposed adjacent at least a portion of the reflective surface, wherein the reflective side wall in cooperation with the reflective surface substantially directs light rays to form a desired lighting pattern.

In another embodiment, a lighting system comprises a trough reflector including a reflective surface having a first portion and a second portion, wherein the second portion is offset relative to the first portion to produce a desired lighting pattern; and a light source disposed adjacent the trough reflector, wherein the trough reflector reflects light emitted by the light source to produce the desired lighting pattern.

In another embodiment, a lighting system for a vehicle headlamp comprises a trough reflector including a reflective surface having a first portion and a second portion, wherein the second portion is offset relative to the first portion to produce a desired lighting pattern; a light source disposed adjacent the trough reflector, wherein the trough reflector reflects light emitted by the light source to produce the desired lighting pattern; and a reflective side wall disposed adjacent at least a portion of the reflective surface, wherein the reflective side wall in cooperation with the reflective surface substantially directs light rays to form the desired lighting pattern.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a lighting system according to an embodiment of the present invention; and

FIG. 2 is a view of a luminous intensity distribution pattern constituting a lighting pattern formed by the light system of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner

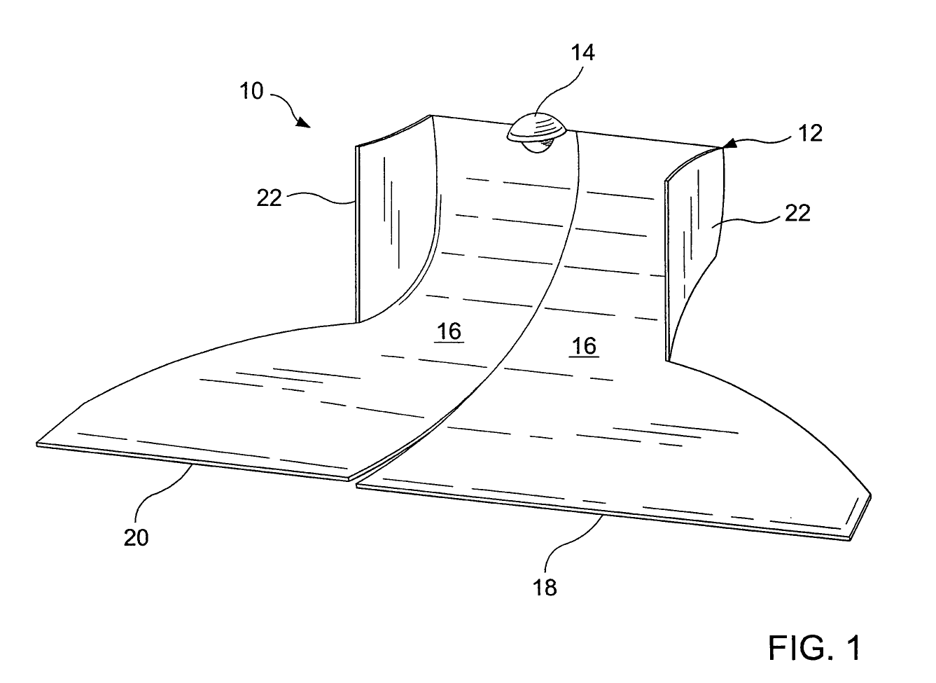

FIG. 1 illustrates a lighting system 10 according to an embodiment of the present invention. The lighting system 10 includes a trough reflector 12 and a light source 14. As shown, the trough reflector 12 is disposed adjacent the light source 14, wherein light emitted by the light source 14 is substantially reflected by the trough reflector 12 into a desired lighting pattern. It is understood that the light source 14 may be any conventional light source such as a light emitting diode or other semi-conductor based light emitting element, for example.

The trough reflector 12 includes a reflective surface 16, having a first portion 18 and a second portion 20, and a pair of spaced apart reflective side walls 22. It is understood that the reflective surface 16 may be formed from any conventional material for reflecting and directing light, as desired.

The reflective surface 16 has a substantially parabolic curvature and is adapted to reflect light in a desired direction. Although the reflective surface 16 is shown having a substantially wing-like shape, it is understood that any shape and size may be used, as desired.

The second portion 20 of the reflective surface is offset relative to the first portion 18. As a non-limiting example, the offset between the first portion 18 and the second portion 20 is formed by at least one of a bending, a rotating, a laminating, and a molding of the reflective surface 16. As shown, the second portion 20 of the reflective surface 16 is bent about a traverse axis of the trough reflector 12. The second portion 20 is offset in the range of 0.3 degrees to 0.5 degrees relative to the first portion 18. However, it is understood that any degree of offset may be used, as desired. It is further understood that the first portion 18 of the reflective surface 16 may be offset to create a desired light pattern.

The reflective side walls 22 may be formed from any conventional material for reflecting and directing light, as desired. The reflective side walls 22 are disposed adjacent the reflective surface 16. As shown, the reflective side walls 22 are disposed on opposing sides of the reflective surface 16 of the trough reflector 12. It is understood that any number of reflective side walls 22 may be used, as desired. As shown, the reflective side walls 22 are curved inwardly, thereby forming a convex inner surface for reflecting light in the desired direction. The resultant reflected light has a substantially smooth distribution. It is understood that the reflective side walls 22 may have any shape and size, as desired. It is further understood that the trough reflector 12 may be disposed in a vehicle headlamp (not shown).

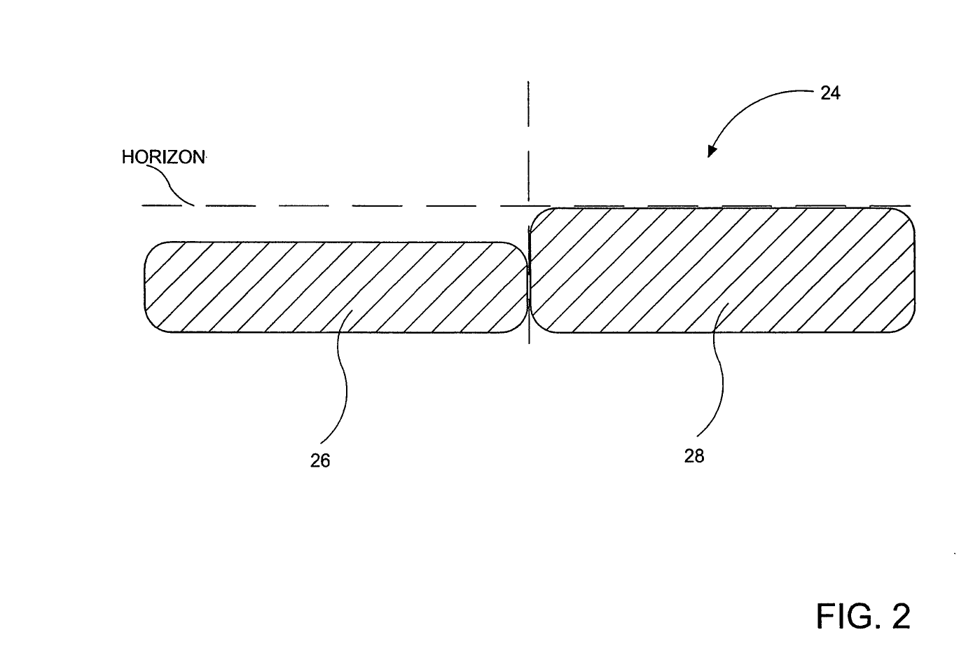

In use, light rays emitted by the light source 14 are substantially reflected by the trough reflector 12 in the desired direction and in a desired lighting pattern. The side walls 22, in cooperation with the reflective surface 16, substantially collect light rays emitted by the light source 14 and direct the light rays in a desired direction. As a non-limiting example, the trough reflector 12 produces a stepped cut-off lighting pattern 24, shown in FIG. 2. As shown, the reflective surface 16 substantially collimates the light rays in the vertical direction and directs the light rays in the stepped cut-off lighting pattern 24. It is understood that the light rays may be collimated and directed in other directions, as desired. In one embodiment, the first potion 18 of the reflective surface 16 facilitates reflecting light rays in a first step lighting pattern 26 consistent with a conventional trough reflector. The second portion of the reflective surface facilitates reflecting light rays in a second step lighting pattern 28. It is understood that the stepped cut-off lighting pattern 24 may be modified by adjusting the offset of the first portion 18 and the second portion 20 of the reflective surface 16. It is further understood that the trough reflector 12 may be included in the vehicle headlamp to provide a lighting pattern consistent with a low beam lighting pattern

The trough reflector 12 according to the present invention facilitates a lighting pattern having a stepped horizontal cut-off, maximizes collection efficiency, and minimizes undesirable beam patterns. The trough reflector 12 may be incorporated into a vehicle headlamp to provide a desired light pattern having a smooth horizontal cut-off such as a low beam pattern, for example.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A trough reflector comprising:
a reflective surface having a substantially parabolic curvature for directing light, wherein the reflective surface includes a first portion and a second portion, the first portion reflecting light in a first lighting pattern and the second portion reflecting light in a second lighting pattern; and
a reflective side wall disposed adjacent at least a portion of the reflective surface, wherein the reflective side wall in cooperation with the reflective surface substantially directs light rays to form a desired lighting pattern.

2. The trough reflector according to claim 1, wherein the trough reflector is disposed adjacent a semi-conductor based light source.

3. The trough reflector according to claim 1, wherein the second portion is offset relative to the first portion.

4. The trough reflector according to claim 1, wherein the second portion is bent relative to the first portion about a traverse axis of the trough reflector to produce the second lighting pattern.

5. The trough reflector according to claim 1, including a pair of spaced apart reflective side walls disposed on opposing sides of the reflective surface.

6. The trough reflector according to claim 5, wherein the reflective side walls have an arcuate shape.

7. The trough reflector according to claim 1, wherein the first lighting pattern and the second lighting pattern cooperate to form a stepped cut-off lighting pattern.

8. The trough reflector according to claim 1, wherein the trough reflector is adapted to be disposed in a vehicle headlamp.

9. A lighting system comprising:
a trough reflector including a reflective surface having a first portion and a second portion, wherein the second portion is offset relative to the first portion to produce a desired lighting pattern; and
a light source disposed adjacent the trough reflector, wherein the trough reflector reflects light emitted by the light source to produce the desired lighting pattern.

10. The trough reflector according to claim 9, wherein the second portion is bent relative to the first portion about a traverse axis of the trough reflector to produce the desired lighting pattern.

11. The light system according to claim 9, wherein the lighting system further includes a plurality of reflective side walls disposed adjacent the reflective surface, wherein the reflective side walls cooperate with the reflective surface to direct light rays from the light source to form the desired lighting pattern.

12. The lighting system according to claim 11, wherein the reflective side walls are spaced apart and disposed on opposing sides of the reflective surface for directing light and limiting a horizontal spread to form the desired lighting pattern.

13. The lighting system according to claim 11, wherein the reflective side walls have an arcuate shape.

14. The lighting system according to claim 9, wherein the first portion of the reflective surface and the second portion of the reflective surface cooperate to produce a stepped cut-off lighting pattern.

15. The light system according to claim 9, wherein the light source is a semi-conductor based light source.

16. A lighting system for a vehicle headlamp comprising:
a trough reflector including a reflective surface having a first portion and a second portion, wherein the second portion is offset relative to the first portion to produce a desired lighting pattern;
a light source disposed adjacent the trough reflector, wherein the trough reflector reflects light emitted by the light source to produce the desired lighting pattern; and
a reflective side wall disposed adjacent at least a portion of the reflective surface, wherein the reflective side wall in cooperation with the reflective surface substantially directs light rays to form the desired lighting pattern.

17. The lighting system according to claim 16, including a pair of spaced apart reflective side walls disposed on opposing sides of the reflective surface.

18. The lighting system according to claim 16, wherein the reflective side walls have an arcuate shape.

19. The lighting system according to claim 16, wherein the first portion of the reflective surface and the second portion of the reflective surface cooperate to produce a stepped cut-off lighting pattern.

20. The light system according to claim 16, wherein the light source is a semi-conductor based light source.
